(19) United States
(12) Patent Application Publication
(10) Pub. No.: US 2026/0309175 A1
(43) Pub. Date: Oct. 8, 2026

(54) CONNECTOR AND ROD MEMBER

(71) Applicants: NANTONG HAWK FITNESS&SPORTS CO., LTD, Nantong (CN); JIANGSU HAWK INDUSTRY GROUP CO., LTD, Taizhou (CN); NANTONG GEMKAL TECH CO., LTD, Nantong (CN)

(72) Inventor: Fangfeng MEI, Nantong (CN)

(21) Appl. No.: 19/679,644

(22) Filed: May 16, 2026

(30) Foreign Application Priority Data
Jun. 13, 2025 (CN) 202521222493.3

(51) Int. Cl. F16B 7/04

(52) U.S. Cl. CPC F16B 7/042

(57) ABSTRACT

The present disclosure provides a connector and a rod member. The connector includes a first sub-body and a second sub-body adapted to each other, where the second sub-body is clamped into the first sub-body, to form a detachable connection; a hole member penetrating the first sub-body is provided in the first sub-body and corresponds to the second sub-body, and a snap fit portion is arranged on a hole wall of the hole member; and n steps are arranged on an outer side wall of the second sub-body, the n steps are arranged in correspondence to the snap fit portion, n is a positive integer greater than or equal to 2, and the steps are arranged in correspondence to the snap fit portion. Adjacent rod bodies of the rod member can be connected through the connector. The rod member applying the connector has a stable and reliable structure, convenient operation, etc.

### TECHNICAL FIELD

The present disclosure relates to a connector and a rod member.

### BACKGROUND OF THE INVENTION

In current sports equipment, in pursuit of higher portability, it is common practice to apply a telescopic rod to equipment using a rod member. However, for fixation or disassembly, it is time-consuming to twist some current telescopic rods employing a threaded connection, especially long rod members. In some cases, a hole member cooperates with a telescopic member. When the telescopic member is required to be extended out and fixed, an inner rod is pulled to a required position, and the telescopic member mounted on the inner rod corresponds to the hole member and is ejected out under the action of an elastic member to penetrate the hole member. When required to be retracted and reset, the telescopic member needs to be manually pushed inwards to separate an end portion of the telescopic member from the hole member. Such an operation process is inconvenient, and has the risk of cutting hand skin of an operator.

### SUMMARY OF THE INVENTION

An objective of the present disclosure is to provide a connector and a rod member, so as to solve one or more of the existing technical problems described above.

The present disclosure provides a connector. The connector includes a first sub-body and a second sub-body adapted to each other, where the second sub-body is clamped into the first sub-body, so as to form a detachable connection; a hole member penetrating the first sub-body is provided in the first sub-body and corresponds to the second sub-body, and a snap fit portion is arranged on a hole wall of the hole member; and n steps are arranged on an outer side wall of the second sub-body, the n steps are arranged in correspondence to the snap fit portion, n is a positive integer greater than or equal to 2, and the steps are arranged in correspondence to the snap fit portion.

In some embodiments, two steps are arranged on the outer side wall of the second sub-body, the two steps are arranged in correspondence to the snap fit portion, the two steps are first steps and second steps, and a distance from the first steps to an upper end of the second sub-body is less than that from the second steps to the upper end of the second sub-body.

In some embodiments,

the second sub-body includes a second body, a lower end of the second body is connected to a boss, a lower end of the boss protrudes to form the second steps, the first steps are arranged on the boss, the first sub-body is connected to the second sub-body, and a distance from a lower end surface of the first sub-body to upper end surfaces of the second steps is less than 1 mm.

In some embodiments,

the hole wall of the hole member is provided with a convex ring as the snap fit portion; and

a plurality of extension sections are arranged at the lower end of the boss in a circumferential direction, gaps are provided between adjacent extension sections, lower ends of the extension sections protrude outwards to form the second steps, and upper edges of the gaps protrude outwards to form the first steps.

In some embodiments,

the plurality of extension sections are evenly arranged at the lower end of the boss in the circumferential direction; and

second groove bodies are provided in the second sub-body, downward openings are provided at bottoms of the second groove bodies, reinforcement structures are arranged in the second groove bodies, the reinforcement structures are connected to groove walls of the second groove bodies, and the reinforcement structures are arranged in correspondence to the extension sections and the gaps.

In some embodiments,

the reinforcement structures include central columns, and first reinforcement ribs and second reinforcement ribs that are arranged around the central columns, and inner ends of the first reinforcement ribs and inner ends of the second reinforcement ribs are connected to the central columns; the first reinforcement ribs are arranged in correspondence to the gaps, outer ends of the first reinforcement ribs are connected to the groove walls of the second groove bodies, and joints correspond to center lines of the gaps in a vertical direction; the second reinforcement ribs are arranged in correspondence to the extension sections, and the central columns and the second reinforcement ribs extend to outer sides of the second groove bodies; upper portions of outer ends of the second reinforcement ribs are connected to the groove walls of the second groove bodies, lower portions of the outer ends of the second reinforcement ribs are connected to inner walls of the extension sections, and joints between the second reinforcement ribs and the extension sections correspond to the center lines of the extension sections in the vertical direction; and

reserved holes are provided in upper portions of the second groove bodies, and the reserved holes penetrate the boss and are in communication with the second groove bodies.

In some embodiments,

a lower end portion of the first sub-body is provided with a plurality of auxiliary extension sections, gaps are provided between adjacent auxiliary extension sections, and clamping grooves are provided in inner side walls of the auxiliary extension sections and correspond to the first steps as the snap fit portion; and

second groove bodies are provided in the second sub-body, downward openings are provided at bottoms of the second groove bodies, a plurality of auxiliary grooves are provided in lower ends of groove walls of the second groove bodies in a circumferential direction, reinforcement structures are arranged in portions, above the auxiliary grooves, of the second groove bodies, and outer ends of the reinforcement structures are connected to the groove walls of the second groove bodies.

In some embodiments,

the lower end portion of the first sub-body is provided with four auxiliary extension sections, two auxiliary extension sections are in one group, so as to form two groups of auxiliary extension sections, the two groups of auxiliary extension sections are evenly distributed at the lower end portion of the first sub-body in the circumferential direction, the clamping grooves in all the auxiliary extension sections are on the same plane, and the first steps are arranged around the boss; and

the reinforcement structures are cross-shaped, a plane where lower ends of the reinforcement structures are located is higher than a plane where upper ends of the auxiliary grooves are located, and positions of the first steps correspond to positions of the upper ends of the auxiliary grooves.

The present disclosure further provides a rod member. The rod member includes any connector described above.

In some embodiments, the rod member includes a plurality of rod bodies, where adjacent rod bodies are connected through the connector, a rod body having a greater diameter of a circle where cross sections of two adjacent rod bodies are located is a larger rod body, and the other rod body is a smaller rod body; a second sub-body is arranged in the larger rod body, a lower end of a first sub-body is inserted into the larger rod body, and an upper end of the first sub-body protrudes to form an auxiliary boss; a diameter of a circle where the auxiliary boss is located is greater than that of a circle where a cross section of an upper end portion of the larger rod body is located; and a lower portion of the smaller rod body penetrates the first sub-body, and is connected to an upper portion of a second body.

The connector and the rod member of the present disclosure have the advantages as follows: the first sub-body and the second sub-body of the connector can be directly injection-molded, and thus are light and low in cost. After the first sub-body is connected to the second sub-body, structural stability and easy disassembly are achieved, and the rod body applying the connector is convenient to stretch and retract, and stable in structure.

### BRIEF DESCRIPTION OF DRAWINGS

FIG. 1 is an exploded view of a connector in Example 1 of the present disclosure;

FIG. 2 is a schematic sectional view of the connector in Example 1 of the present disclosure;

FIG. 3 is a schematic structural diagram of the connector in Example 1 of the present disclosure;

FIG. 4 is an exploded view of a connector in Example 2 of the present disclosure;

FIG. 5 is a schematic sectional view of the connector in Example 2 of the present disclosure;

FIG. 6 is a schematic structural diagram of the connector in Example 2 of the present disclosure; and

FIG. 7 is a schematic structural diagram of a rod member in some embodiments of the present disclosure.

### DETAILED DESCRIPTION OF THE INVENTION

A connector is described in the present disclosure. The connector includes a first sub-body and a second sub-body adapted to each other, where the second sub-body is clamped into the first sub-body, so as to form a detachable connection; a hole member is provided in the first sub-body and corresponds to the second sub-body, and a snap fit portion is arranged on a hole wall of the hole member; n steps are arranged on an outer side wall of the second sub-body, the n steps are arranged in correspondence to the snap fit portion, n is a positive integer greater than or equal to 2, and the steps are arranged in correspondence to the snap fit portion. A specific structure is illustratively described below with the connector having two steps as an example.

### Example 1

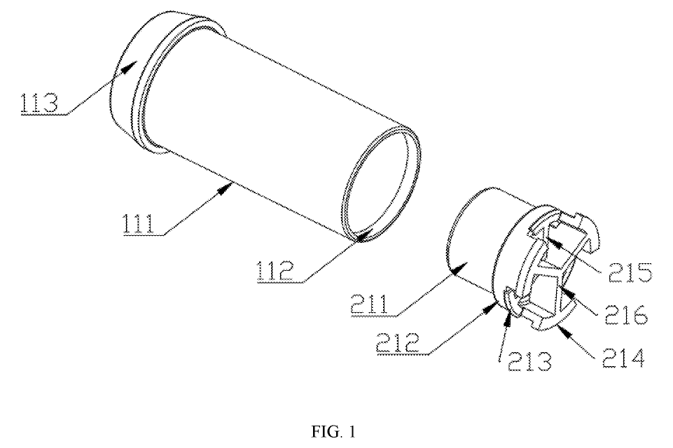

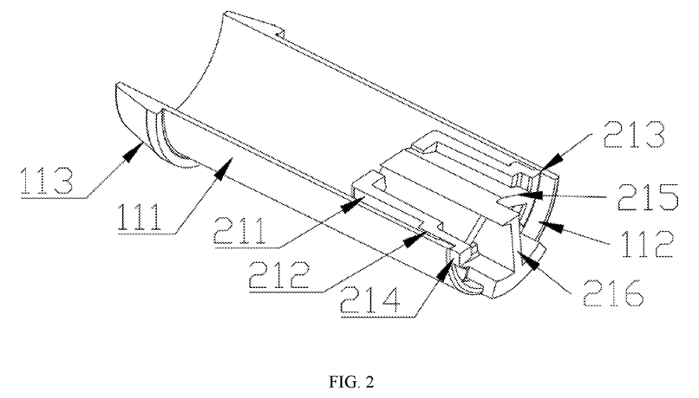

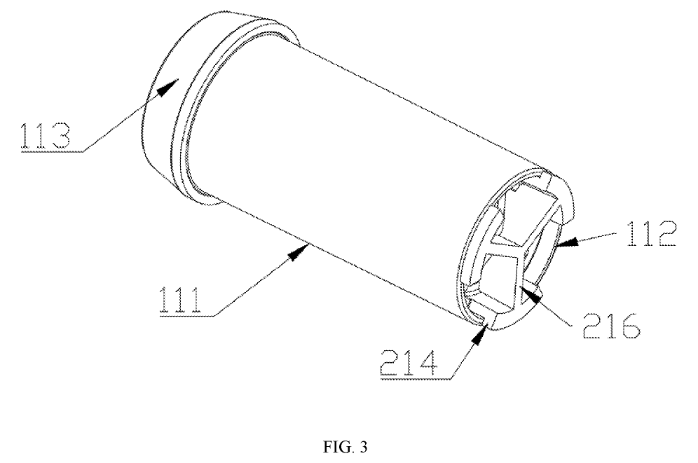

In combination with the contents shown in FIGS. 1-3, a connector is described in the example. The connector includes a first sub-body and a second sub-body adapted to each other, where two steps are arranged on an outer side wall of the second sub-body, the two steps are arranged in correspondence to a snap fit portion, the two steps are first steps and second steps, and a distance from the first steps to an upper end of the second sub-body is less than that from the second steps to the upper end of the second sub-body.

The first sub-body includes a first body 111, a hole member penetrating the first body 111 is provided in the first body 111 and corresponds to the second sub-body, and a lower end of an inner wall of the hole member is provided with a convex ring 112 as the snap fit portion.

The second sub-body includes a second body 211, a lower end of the second body 211 is connected to a first boss 212, a plurality of extension sections are arranged on a lower end of the first boss 212 in a circumferential direction, gaps are provided between adjacent extension sections, lower ends 214 of the extension sections protrude outwards to form the second steps, and upper edges 213 of the gaps protrude outwards to form the first steps. The first sub-body is connected to the second sub-body, and a distance from a lower end surface of the first sub-body to upper end surfaces of the second steps may be controlled within 1 mm. When the boss is round, the plurality of extension sections may be evenly distributed at the lower end of the boss in the circumferential direction.

Second groove bodies are provided in the second sub-body, downward openings are provided at bottoms of the second groove bodies, reinforcement structures may be additionally arranged in the second groove bodies, the reinforcement structures are connected to groove walls of the second groove bodies, and the reinforcement structures are arranged in correspondence to the extension sections and the gaps. The reinforcement structure may be specifically as follows:

the reinforcement structures include central columns (the central columns may be single bodies or intersections between first reinforcing ribs and second reinforcing ribs), and the first reinforcement ribs 215 and the second reinforcement ribs 216 that are arranged around the central columns; inner ends of the first reinforcement ribs 215 and inner ends of the second reinforcement ribs 216 are connected to the central columns; the first reinforcement ribs 215 are arranged in correspondence to the gaps, outer ends of the first reinforcement ribs 215 are connected to the groove walls of the second groove bodies, and joints and center lines of the gaps in a vertical direction may be located on the same plane; the second reinforcement ribs 216 are arranged in correspondence to the extension sections, and the central columns and the second reinforcement ribs 216 extend to outer sides of the second groove bodies; and upper portions of outer ends of the second reinforcement ribs 216 are connected to the groove walls of the second groove bodies, lower portions of the outer ends of the second reinforcement ribs 216 are connected to inner walls of the extension sections, and joints between the second reinforcement ribs 216 and the extension sections and the center lines of the extension sections in the vertical direction may be located on the same plane.

Reserved holes are provided in upper portions of the second groove bodies, and the reserved holes penetrate the boss and are in communication with the second groove bodies. Thus, the snap fit operation is more convenient to perform.

An upper end 113 of an outer side wall of the first body 111 protrudes outwards to form an auxiliary boss.

When the first sub-body is connected to the second sub-body, the convex ring 112 is embedded between the first steps and the second steps, and the convex ring 112 is fixed through the first steps and the second steps.

### Example 2

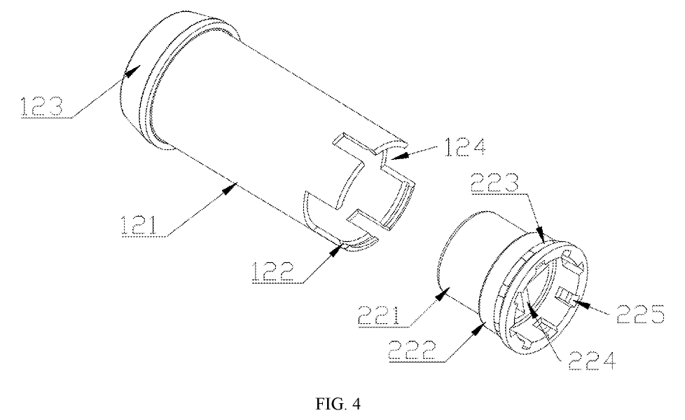

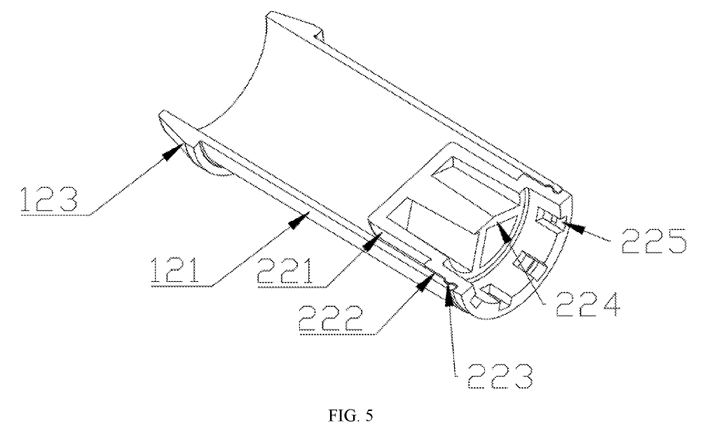

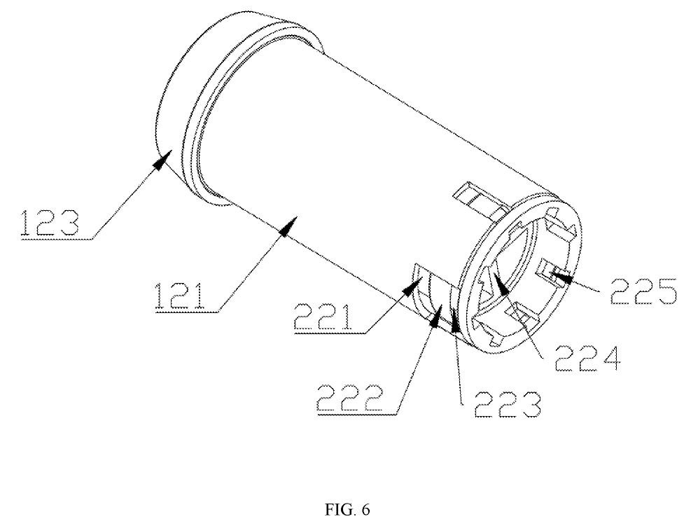

In combination with the contents shown in FIGS. 4-6, a connector is described in the example. The connector includes a first sub-body and a second sub-body adapted to each other, where two steps are arranged on an outer side wall of the second sub-body, the two steps are arranged in correspondence to a snap fit portion, the two steps are first steps and second steps, and a distance from the first steps to an upper end of the second sub-body is less than that from the second steps to the upper end of the second sub-body.

The first sub-body includes a third body 121, a hole member penetrating the third body 121 is provided in the third body 121 and corresponds to the second sub-body, a lower end portion of the third body 121 is provided with a plurality of auxiliary extension sections, gaps 124 are provided between adjacent auxiliary extension sections, and clamping grooves 122 are provided in inner side walls of the auxiliary extension sections and correspond to the first steps as the snap fit portion.

The lower end portion of the third body 121 is provided with four auxiliary extension sections, the auxiliary extension sections on the lower end portion of the first sub-body may be divided into two groups, and each group includes two auxiliary extension sections. The two groups of auxiliary extension sections are evenly distributed at the lower end portion of the first sub-body in a circumferential direction, the clamping grooves in all the auxiliary extension sections are on the same plane, and the first steps are arranged around the boss.

The second sub-body includes a fourth body 221, a lower end of the fourth body 221 is connected to a second boss 222, a lower end of the second boss 222 protrudes to form the second steps, and an auxiliary convex ring 223 is further arranged around the second boss as the first steps. The first sub-body is connected to the second sub-body, and a distance from a lower end surface of the first sub-body to upper end surfaces of the second steps may be controlled within 1 mm.

Second groove bodies are provided in the fourth body 221, downward openings are provided at bottoms of the second groove bodies, a plurality of auxiliary grooves 225 are provided in lower ends of groove walls of the second groove bodies in a circumferential direction, reinforcement structures 224 are arranged in portions, above the auxiliary grooves 225, of the second groove bodies, and outer ends of the reinforcement structures 224 are connected to the groove walls of the second groove bodies.

The reinforcement structures 224 may be cross-shaped, a plane where lower ends of the reinforcement structures 224 are located is higher than a plane where upper ends of the auxiliary grooves are located, and positions of the first steps correspond to positions of the upper ends of the auxiliary grooves.

When the first sub-body is connected to the second sub-body, the auxiliary convex ring 223 is embedded in the clamping grooves 122.

An upper end 123 of an outer side wall of the third body 121 protrudes outwards to form an auxiliary boss.

The first sub-body and the second sub-body may be injection-molded from plastic.

The first sub-body and the second sub-body in Example 1 and the first sub-body and the second sub-body in Example 2 may be used in joint cooperation when adapted in size.

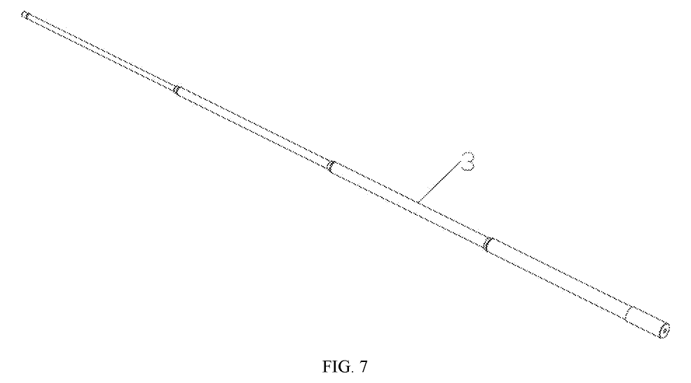

A rod member is further provided in the present disclosure. In combination with the contents shown in FIG. 7, the rod member is a telescopic rod member. The rod member 3 includes a plurality of rod bodies, where adjacent rod bodies are connected through any connector in Examples 1 or 2. A rod body having a greater diameter of a circle where cross sections of two adjacent rod bodies are located (when the cross sections are non-circular, the circle where the cross sections are located is a circumscribed circle corresponding to outer contours of the cross sections) is a larger rod body, and the other rod body is a smaller rod body. A second sub-body is arranged in the larger rod body, a lower end of a first sub-body is inserted into the larger rod body, and an upper end of the first sub-body protrudes to form an auxiliary boss. A diameter of a circle where the auxiliary boss is located (when the auxiliary boss is non-circular, the circle where the auxiliary boss is located is a circumscribed circle corresponding to an outer contour of the auxiliary boss) is greater than that of a circle where a cross section of an upper end portion of the larger rod body is located. A lower portion of the smaller rod body penetrates the first sub-body, and is connected to an upper portion of a second body.

When the rod member is extended out and fixed, the rod bodies are stretched, so that the second sub-bodies between adjacent rod bodies are embedded in the first sub-bodies, so as to be connected. When the rod member needs to be retracted, a connection relation between the first sub-bodies and the second sub-bodies can be released only by slightly bumping a bottom of the larger rod body against a bottom surface, and then pressing the smaller rod body downwards with force. Finally, the smaller rod body can drive the second sub-bodies to fall into adjacent larger rod bodies.

The matters not disclosed above can be implemented through the prior art, and thus are not repeated herein.

The matters not disclosed above can be implemented through the prior art, and thus are not repeated herein.

Finally, it should be noted that in the description of the present disclosure, the orientation or position relations indicated by the terms “vertical”, “upper”, “lower”, “left”, “right”, “horizontal”, etc. are based on the orientation or position relations shown in the accompanying drawings, are merely for facilitating the description of the present disclosure and simplifying the description, rather than indicating or implying that the device or element referred to must have a particular orientation or be constructed and operated in a particular orientation, and thus cannot be interpreted as limiting the present disclosure.

In the description of the present disclosure, it should be further noted that the terms “arrange”, “provide”, “mount”, “connect”, and “connection” should be understood in a broad sense, and for example, they can denote a fixed connection, a detachable connection, an integrated connection, a mechanical connection, an electrical connection, a direct connection, an indirect connection via an intermediate medium, or communication inside two elements, unless explicitly specified and defined otherwise. For those of ordinary skill in the art, the specific meanings of the above terms in the present disclosure can be understood according to specific circumstances.

What are described above are used to further describe the present disclosure in detail in combination with particular embodiments, and it cannot be deemed that the specific implementation of the present disclosure is limited to these descriptions. For those of ordinary skill in the art to which the present disclosure belongs, several simple deductions or substitutions can be made without departing from the concept of the present disclosure, and should be deemed as falling within the scope of protection determined by the claims submitted in the present disclosure.

1. A connector, comprising a first sub-body and a second sub-body adapted to each other, wherein the second sub-body is clamped into the first sub-body, so as to form a detachable connection; a hole member penetrating the first sub-body is provided in the first sub-body and corresponds to the second sub-body, and a snap fit portion is arranged on a hole wall of the hole member; and n steps are arranged on an outer side wall of the second sub-body, the n steps are arranged in correspondence to the snap fit portion, n is a positive integer greater than or equal to 2, and the steps are arranged in correspondence to the snap fit portion.

2. The connector according to claim 1, wherein two steps are arranged on the outer side wall of the second sub-body, the two steps are arranged in correspondence to the snap fit portion, the two steps are first steps and second steps, and a distance from the first steps to an upper end of the second sub-body is less than that from the second steps to the upper end of the second sub-body.

3. The connector according to claim 2, wherein
the second sub-body comprises a second body, a lower end of the second body is connected to a boss, a lower end of the boss protrudes to form the second steps, the first steps are arranged on the boss, the first sub-body is connected to the second sub-body, and a distance from a lower end surface of the first sub-body to upper end surfaces of the second steps is less than 1 mm.

4. The connector according to claim 3, wherein
the hole wall of the hole member is provided with a convex ring as the snap fit portion; and
a plurality of extension sections are arranged at the lower end of the boss in a circumferential direction, gaps are provided between adjacent extension sections, lower ends of the extension sections protrude outwards to form the second steps, and upper edges of the gaps protrude outwards to form the first steps.

5. The connector according to claim 4, wherein
the plurality of extension sections are evenly arranged at the lower end of the boss in the circumferential direction; and
second groove bodies are provided in the second sub-body, downward openings are provided at bottoms of the second groove bodies, reinforcement structures are arranged in the second groove bodies, the reinforcement structures are connected to groove walls of the second groove bodies, and the reinforcement structures are arranged in correspondence to the extension sections and the gaps.

6. The connector according to claim 5, wherein
the reinforcement structures comprise central columns, and first reinforcement ribs and second reinforcement ribs that are arranged around the central columns, and inner ends of the first reinforcement ribs and inner ends of the second reinforcement ribs are connected to the central columns; the first reinforcement ribs are arranged in correspondence to the gaps, outer ends of the first reinforcement ribs are connected to the groove walls of the second groove bodies, and joints correspond to center lines of the gaps in a vertical direction; the second reinforcement ribs are arranged in correspondence to the extension sections, and the central columns and the second reinforcement ribs extend to outer sides of the second groove bodies; upper portions of outer ends of the second reinforcement ribs are connected to the groove walls of the second groove bodies, lower portions of the outer ends of the second reinforcement ribs are connected to inner walls of the extension sections, and joints between the second reinforcement ribs and the extension sections correspond to the center lines of the extension sections in the vertical direction; and
reserved holes are provided in upper portions of the second groove bodies, and the reserved holes penetrate the boss and are in communication with the second groove bodies.

7. The connector according to claim 3, wherein
a lower end portion of the first sub-body is provided with a plurality of auxiliary extension sections, gaps are provided between adjacent auxiliary extension sections, and clamping grooves are provided in inner side walls of the auxiliary extension sections and correspond to the first steps as the snap fit portion; and
second groove bodies are provided in the second sub-body, downward openings are provided at bottoms of the second groove bodies, a plurality of auxiliary grooves are provided in lower ends of groove walls of the second groove bodies in a circumferential direction, reinforcement structures are arranged in portions, above the auxiliary grooves, of the second groove bodies, and outer ends of the reinforcement structures are connected to the groove walls of the second groove bodies.

8. The connector according to claim 7, wherein
the lower end portion of the first sub-body is provided with four auxiliary extension sections, two auxiliary extension sections are in one group, so as to form two groups of auxiliary extension sections, the two groups of auxiliary extension sections are evenly distributed at the lower end portion of the first sub-body in the circumferential direction, the clamping grooves in all the auxiliary extension sections are on the same plane, and the first steps are arranged around the boss; and
the reinforcement structures are cross-shaped, a plane where lower ends of the reinforcement structures are located is higher than a plane where upper ends of the auxiliary grooves are located, and positions of the first steps correspond to positions of the upper ends of the auxiliary grooves.

9. A rod member, comprising the connector according to claim 1.

10. The rod member according to claim 9, comprising a plurality of rod bodies, wherein adjacent rod bodies are connected through the connector, a rod body having a greater diameter of a circle where cross sections of two adjacent rod bodies are located is a larger rod body, and the other rod body is a smaller rod body; a second sub-body is arranged in the larger rod body, a lower end of a first sub-body is inserted into the larger rod body, and an upper end of the first sub-body protrudes to form an auxiliary boss; a diameter of a circle where the auxiliary boss is located is greater than that of a circle where a cross section of an upper end portion of the larger rod body is located; and a lower portion of the smaller rod body penetrates the first sub-body, and is connected to an upper portion of a second body.
